(19) United States
(12) Patent Application Publication
(10) Pub. No.: US 2012/0215700 A1
(43) Pub. Date: Aug. 23, 2012

(54) PAYMENT SYSTEMS AND METHODS USING MOBILE COMPUTING DEVICES

(75) Inventors: Kevin Bernhard Falk, Vancouver (CA); Ryan Walter Volberg, Anmore (CA)

(73) Assignee: VIVONET, INC., Burnaby (CA)

(21) Appl. No.: 13/354,683

(22) Filed: Jan. 20, 2012

Related U.S. Application Data
(60) Provisional application No. 61/457,289, filed on Feb. 18, 2011.

(51) Int. Cl. G06Q 20/40; G06Q 20/38

(52) U.S. Cl. 705/67; 705/65

(57) ABSTRACT

Systems and methods for the processing of payments to retail establishments using mobile computing devices. A user of a mobile computer device takes a digital image of a specific bar code at a retail establishment. A token is then derived from the bar code and the token is transmitted by the device to a server with whom the device and its user are registered with. The retail establishment packages the details regarding the proposed purchase by the user along with a token derived from the same bar code. The retail establishment then sends the package to the same server. The server then checks the two tokens received and, if they match, then the server effects payment from one of the user's payment options to the retail establishment. Both the user and the retail establishment are then notified of the payment.

### RELATED APPLICATIONS

This application claims priority on U.S. Patent Application Ser. No. 61/457,289 filed Feb. 18, 2011.

### TECHNICAL FIELD

The present invention relates to payment methods. More specifically, the present invention relates to payment methods for use with mobile computing devices involving minimal user interaction.

### BACKGROUND OF THE INVENTION

The explosion in the use and ubiquity of mobile computing devices has led to the development of a multitude of uses for these devices. Users can now not only go online, buy books, check a plot of the stars, and even order food using their mobile devices. However, there still has not been an easy to use method for paying for goods and services using the mobile device.

Such a method should allow users to simply scan/activate their mobile devices at a point of sale terminal at a retail establishment to effect payment for goods or services purchased at that retail establishment.

Currently, some retailers allow mobile users to pay for their purchases by having an application on the mobile computing device that displays a specific bar code on the mobile computing devices screen. The bar code is then scanned at the point of sale terminal and the amount for the purchase is taken from mobile computing device user's account with the retailer. This system, however, is specific to retailers—there is currently no method by which a user can pay any retailer the amount for goods or services purchased.

### SUMMARY OF INVENTION

The present invention provides systems and methods for the processing of payments to retail establishments using mobile computing devices. A user of a mobile computer device takes a digital image of a specific bar code at a retail establishment. A token is then derived from the bar code and the token is transmitted by the device to a server with whom the device and its user are registered with. The retail establishment packages the details regarding the proposed purchase by the user along with a token derived from the same bar code. The retail establishment then sends the package to the same server. The server then checks the two tokens received and, if they match, then the server effects payment from one of the user's payment options to the retail establishment. Both the user and the retail establishment are then notified of the payment.

In a first aspect, the present invention provides a method for processing payments for a retail establishment, the method comprising:
a) receiving at a server a first token from an identified user, said user being identified by said server;
b) receiving at said server a second token from said retail establishment, said second token being received from said retail establishment and being sent to said server with details regarding a retail transaction at said retail establishment;
c) determining if said first token and said second token match each other;
d) in the event said first token and said second token match each other, matching said details with said identified user in said server;
e) paying said retail establishment for said retail transaction on behalf of said identified user.

In a second aspect, the present invention provides a method for paying for a retail transaction at a retail establishment for a user of a mobile computing device, the method comprising:
a) obtaining a token at said retail establishment by way of said mobile device;
b) transmitting said token to a server using said mobile device, said mobile device being registered and identified with said server and said mobile device being associated with at least one payment method with said server;
c) receiving from said server a confirmation that a payment for a retail transaction has been made;

wherein
said confirmation from said server indicates that said server has received details regarding said retail transaction conducted at said retail establishment.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention; and

FIG. 2 is a flowchart illustrating the steps in a method according to another aspect of the invention.

### DETAILED DESCRIPTION OF THE INVENTION

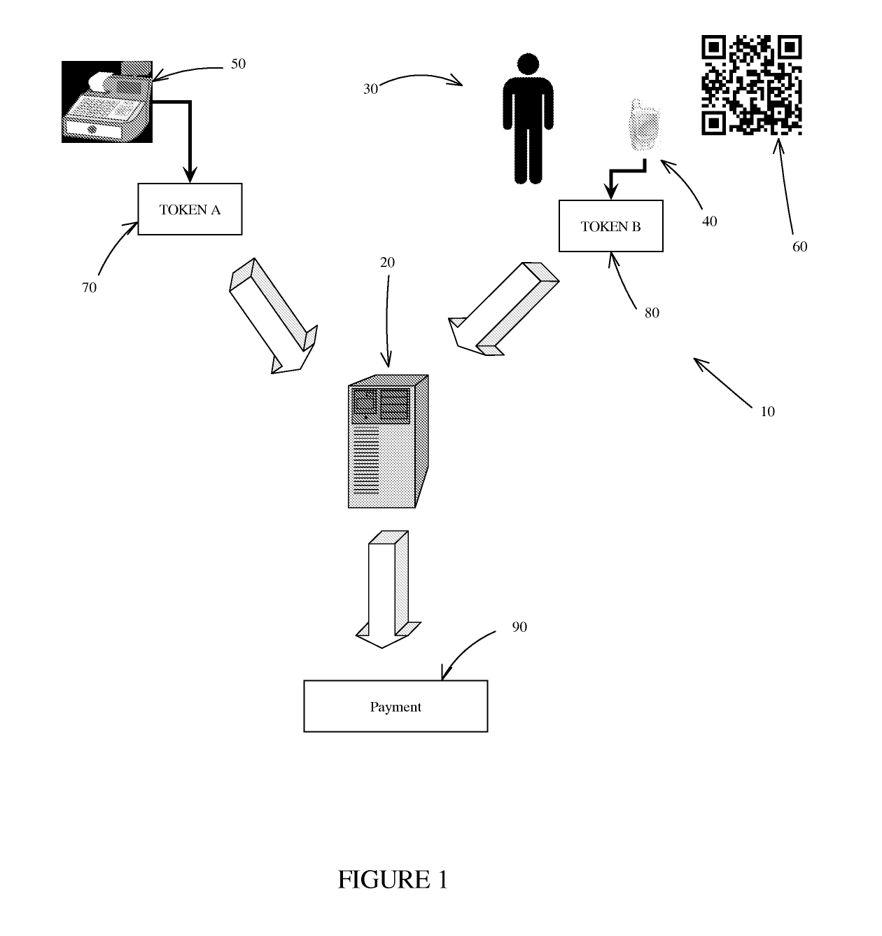

Referring to FIG. 1, a system according to one embodiment of the invention is illustrated. As can be seen, the system 10 has a server 20. User 30 is identified and registered with the server 10 as well as the mobile device 40 that user 30 uses. Also registered and identified with the server 20 is the point of sale (POS) terminal 50 at a retail establishment. The POS terminal 50 and the retail establishment are identified and registered with the server 20 so that server 20 can associate data coming from POS terminal 50 as coming from the specific retail establishment.

If user 30 is at the retail establishment and wishes to purchase goods or services from the establishment, the sale is rung in at the POS terminal 50. The details of the transaction (goods/services sold, quantity, etc., etc.) are packaged by the POS terminal 50 along with a first token 70 (identified as Token A in FIG. 1) to the server 20. To pay for the transaction, user 30 takes a digital image of a 2D barcode 60 (other types of barcodes may be used as well as other types of information containing indicia which may be deployed near a POS). The digital image is then processed by software on the mobile device 40 to derive a second token 80 (listed as Token B in FIG. 1). The second token, along with an identification of the sending mobile device 40, is sent by the mobile device 40 to the server 20.

Once the server 20 receives both first 70 and second 60 tokens, the server 20 then determines if the tokens match one another. If there is a match, then the server 20 can pay for the transaction using whatever payment options 90 user 30 has registered with the server 20. As an example, the server 20 may charge the amount for the transaction (taken from the details of the transaction received from the POS terminal 50) to a credit card, a bank account, or any other financial instrument or institution which user 30 has registered with the server 20. Once the payment has gone through (e.g. the funds have been transferred to the retail establishment's bank account or a charge to the credit card has been approved automatically), the server 20 can then send messages to either or both of the POS terminal and the user 30 by way of the mobile device 40.

In one variant of the invention, before the server 20 effects payment for the transaction, the details of the transaction are sent to the mobile device by the server 20 for confirmation by the user 30. Once the user 30 checks the details, he/she can confirm to the server 20 that payment can be made for the transaction.

Alternatively, the user 30 may configure his/her account with the server 20 so that confirmation is not required—any authenticated transactions (i.e. transactions where the tokens from the mobile device and the retail establishment match one another) are automatically approved and payment to the retail establishment is automatically done by the server 20.

In another variant of the invention, instead of having the payment information (e.g. credit card number, bank account details, etc.) stored on the server, these details could be stored on the mobile computing device. These details could be sent to the server along with the token from the bar code. Once the server authenticates the token from the user, the server can then make the payment to the retailer using the payment information it has received from the mobile computing device.

It should be noted that communications between the server 20 and the mobile device 40 may be over a wireless network and over the Internet. Communications between the POS terminal 50 and the server 20 may also be over the Internet or any other suitable network connecting the two.

Regarding the tokens used in the invention, the tokens can be derived from the information encoded in the bar code or the token can be the information encoded in the bar code. It should be noted that the bar code can be fixed or it can be unique. For the fixed bar code concept, the bar code can be displayed at a point-of-sale terminal, printed on a physical printout for the user to scan, or printed on a table or specific location at the retail establishment. Once the user has scanned the fixed bar code, the token derived from the bar code (either derived from the information encoded in the bar code or the encoded information itself) can be used to match/associate the transaction with the user/account so the bill can be paid. As noted, the fixed bar code cannot be used by another while a user is completing his/her transaction. For the unique bar code concept, the point of sale terminal generates a unique bar code that is unique to the specific transaction. This unique bar code can be displayed on a screen facing the user and next to the POS terminal or it can be physically printed for the user to scan.

In one embodiment of the invention, when user 30 is about to pay for his/her purchase, the user 30 simply takes a digital image of a barcode at the POS terminal. Token A is then derived from the barcode and the token A is sent from the mobile device to the server 20. The POS terminal then sends the details of the transaction to be paid for to the server 20 along with Token B. If the server determines that Tokens A and B are a match, then payment can be effected.

In the above embodiment of the invention, the bar code from the POS terminal does not vary. When the token from the POS terminal is being used by the server 20, no other user can pay for their purchase from the same POS terminal. The token and the specific POS terminal are therefore “locked” until the transaction is completed. Using the same concept, the bar code used by the user at that POS terminal is also “locked” until the transaction is completed. Thus, no other user can use that specific bar code until the transaction is completed.

Of course, in the embodiment noted above, each POS terminal in the retail establishment is provided with a different bar code so that multiple users can pay for purchases in parallel.

In another embodiment of the invention, the bar code at the POS terminal can be digitized by the user (using the mobile device, of course) from a small LCD (liquid crystal display) panel or some other customer facing display panel. The bar code to be digitized can be one of a number of different bar codes. The bar codes are rotated among the different POS terminals so that no two POS terminals are using the same bar code (for user transactions) at the same time. Each retail location can therefore have multiple bar codes (and hence different tokens) for its use. These are rotated in sequence or randomly and each token associated with each bar code is rotated/randomized along with their associated bar code.

Another variant of the invention also uses multiple bar codes and multiple tokens for each retail location and is most applicable to restaurants. In this variant, each table at the retail location (e.g. a restaurant) is assigned a non-changing (i.e. fixed) bar code. A user at a specific table takes a digitized image of the bar code for that table and all charges to that table are then associated with the token for the bar code for that table. Once the user is ready to pay for the charges, all the detail for the charges to the table are packaged by the retail establishment and sent, along with the token for the bar code for the table, to the server. The user, having already taken a digital image of the bar code for the table, then automatically has the mobile device to derive the token from the bar code and send the token to the server along with the mobile device's identity. The server then matches the tokens received from the mobile device and the retail establishment. Once these are matched, the server can then effect payment for the charges for the table occupied by the user. The user therefore does not even have to have a bill or to go to a POS terminal as the server merely has to ask for the user's approval to make the payment. Of course, if configured as such, the server does not necessarily even need to request for such a confirmation from the user.

A variant of the invention allows the user to remain anonymous to the retail establishment while still being identified to the server. In this variant, each retail establishment is allocated a series of changing sets of identifiers, these identifiers possibly being unique to the retail establishment. In one example, retail establishment A would have the set of colors Blue, Yellow, Green, Purple, Black, and White. Along with this set could be a set of animals Dog, Cat, Goldfish, Ferret, and Hamster. Between the two sets, there are 30 possible combinations (e.g. Purple Dog, Blue Goldfish, etc.) among the sets. The user can, when he arrives at the retail establishment, select a pairing from the available sets of identifiers. As an example, the user can select the color Blue and the animal Hamster as long as these identifiers are still available at the retail establishment. The user can then enter Blue Hamster as his identifier for that retail establishment for that transaction. The retail establishment will then use the token associated with the identifier Blue Hamster for the user's purchases for that transaction. As with the bar code concept, the token to be used by the user would be derived from the identifier he has selected. Of course, once the user has selected a specific identifier, that identifier is no longer available to other users at that particular retail establishment (or, if it is a retail chain, the identifier is no longer available to other users at that particular location).

Once the identifier has been selected, the user need not identify himself to the retail establishment. The server, after receiving the user's transmission with his identifier, can match the token from the retailer (and the transaction details) with the token from the user's mobile device. Using this system, the user is never identified by the retail establishment as the user's identity and payment information is only known to the server. Once payment has been effected, the retailer merely knows that whoever had the identifier Blue Hamster has paid his bill.

The above variant can, of course be used with varying numbers of identifier sets from which the user may choose his identifier. As well, the number and type of identifiers in an identifier set may vary depending on the implementation and preferences.

To determine which retail establishment the user is in, the user can either positively identify the retailer by logging in to the server and noting the retailer and the retailer's location. If the retailer is registered with the server and can access the payment features of the server, then the retailer or its POS terminal can send the relevant token when the user wants to pay for his purchases.

Alternatively, the user's mobile device, if equipped with GPS functionality, can use that functionality to determine the retail establishment where the mobile device is currently located. Once this has been determined, the mobile device can automatically notify the server of the identity of the retail establishment.

Knowledge of the retail establishment and its location may be important as the server can thereby determine which bar codes/tokens are available for that retail establishment or for the retail establishment at that location. That being said, knowledge of the location would be more useful for the variant that uses a series of changing sets of paired identifiers mentioned above. The variant that uses a barcode does not require knowledge of the location as the barcode is uniquely tied to the transaction, POS terminal or table at the retailer.

For clarity, it must be noted that the above scheme allows for a reuse of tokens and/or barcodes within a retail chain. As an example, if retail chain A has locations A1, A2, A3, the barcode/token pair B can be used at each location as long as the token sent to the server 20 includes an indication as to which location the token is coming from. The server can thus differentiate between the same token being used by different locations and by different users.

It should be noted that the server 20 is preferably provisioned to have multiple incoming and outgoing connections so that multiple retail establishments and multiple users can simultaneously avail of its server.

It should further be noted that the term “server” encompasses multiple servers functioning either as a group or as multiple individual servers providing the functions described above.

As a further variant of the invention, the server may preferably store the details regarding each user's transactions in a database. The database can then be mined for information so that targeted marketing campaigns may be created using offers which may be of interest and/or value to the user.

Regarding the mobile computing devices mentioned above, any smartphone, tablet device, or data processing device having the ability to take digital images, process a digital image of a barcode (2d or otherwise), and transmit data derived from the barcode may be used. The iPhone and certain versions of the iPad from Apple Computers are well-suited for this function along with smartphones and other computing devices based on the various flavors or versions of Android, WinCE, Windows Mobile, BlackBerry OS, Symbian and other mobile operating systems may also be used.

In a further variant of the invention, the services and functions of the server may be subscription based. Users wishing to avail of the ease of payment that the system provides may subscribe to the service and pay a fee for the convenience. Of course, as noted above, the user and his or her mobile device would need to be identified to the server. Communications from the mobile device to the server would have to be identifiable by the server as originating from the mobile device and would have to be associated with the user's account. Preferably as well, communications to and from the server, whether with the mobile device or the retailer or a POS terminal, are encrypted for security.

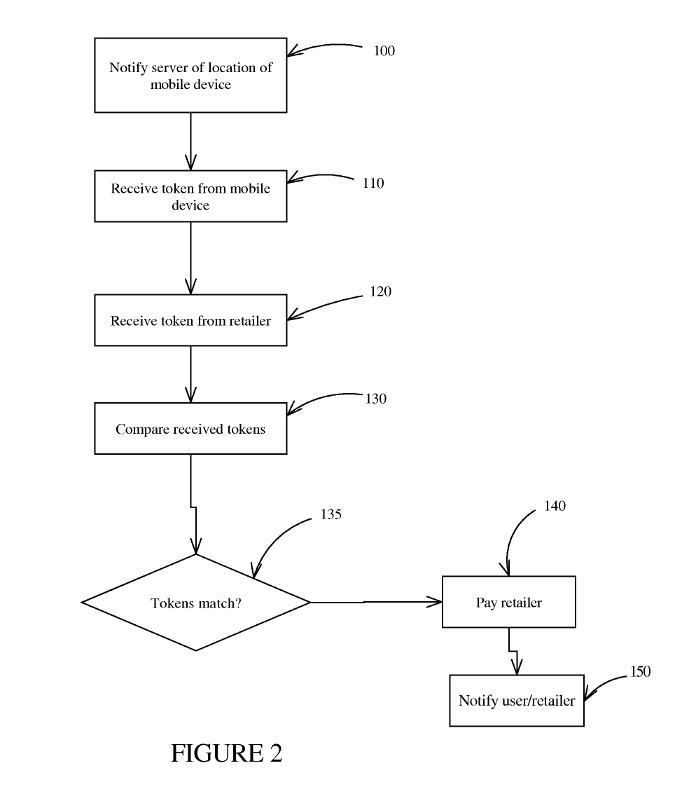

The process followed by the server according to one aspect of the invention is illustrated in the flowchart of FIG. 2. As can be seen, the server initially is notified of the user's presence (or the user's mobile device being present) at a specific retail establishment (step 100). This can be done automatically with the mobile device determining its location via, for example, GPS. Or, alternatively, the user may manually enter into the mobile device the location and/or identity of the retail establishment. Step 110 is that of the server receiving a token from the user's mobile device, the token being derived from a digital image taken by the mobile device of a bar code at the retail establishment. Step 120 is that of the server receiving another token, along with details of a retail transaction, from the retail establishment. The server then compares the two tokens received to determine if they match (steps 130-135). A match would involve checking to ensure that not only do the tokens match but that the location of the user's mobile device matches the location of the retail establishment sending the token with the transaction details. This checking may involve sending the user's mobile a confirmation message to confirm not only the details of the transaction but also the location of the mobile device. Alternatively, the user's account may be set up so that no confirmation is required and any “authenticated” transaction (transactions where the tokens match one another and transactions that are otherwise deemed in order) is automatically considered approved by the user.

Once the checking is done and the tokens match, the server can then proceed to pay for the transaction on the user's behalf (step 140). This may involve charging the user's credit card, transferring funds from the user's bank account to the retail establishment's bank account, or any other suitable mechanism to transfer funds or credit from the user to the retailer. Of course, this step may involve other third party entities such as banks, credit card companies, etc. In one variant, the server may either pay the transaction directly through a payment gateway or send it to the terminal for the terminal to effect the payment and send confirmation back to the server.

Once the server has sent payment, the server can send out a confirmatory message to either or both of the retailer and the user (step 150).

It should be noted that while the flowchart and the explanation above begins with the server being notified of the user's presence or location at the retail establishment (step 100), this step is not necessary in the embodiment that uses bar codes where the bar codes are associated with specific retailers or retail locations. For this embodiment, the server does not need to know the location or the retail establishment as the token from the bar code scanned by the user, along with the token from the retailer, are all that is required for the server to effect payment for the transaction. If bar codes or identifiers are being reused or are not specifically associated with specific retailers or locations, then the location of the user may need to be transmitted to the server.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for processing payments for a retail establishment, the method comprising:
a) receiving at a server a first token from an identified user, said user being identified by said server;
b) receiving at said server a second token from said retail establishment, said second token being received from said retail establishment and being sent to said server with details regarding a retail transaction at said retail establishment;
c) determining if said first token and said second token match each other;
d) in the event said first token and said second token match each other, matching said details with said identified user in said server;
e) paying said retail establishment for said retail transaction on behalf of said identified user.

2. A method according to claim 1 wherein, prior to step e), said server requests and receives confirmation from said identified user regarding said details of said retail transaction.

3. A method according to claim 1 wherein said first token is derived from a digital image taken by said identified user of an optical machine-readable representation of data, said representation being located at said retail establishment.

4. A method according to claim 1 wherein said first token is selected by said identified user from a group of available tokens for said retail establishment.

5. A method according to claim 1 wherein said first token is fixed for each point of sale terminal at said retail establishment.

6. A method according to claim 1 wherein said retail establishment is a restaurant.

7. A method according to claim 6 wherein each table at said retail establishment is assigned a fixed first token to be obtained by said identified user.

8. A method according to claim 1 wherein said first token is selected by said retail establishment from a group of available tokens.

9. A method for paying for a retail transaction at a retail establishment for a user of a mobile computing device, the method comprising:
a) obtaining a token at said retail establishment by way of said mobile device;
b) transmitting said token to a server using said mobile device, said mobile device being registered and identified with said server and said mobile device being associated with at least one payment method with said server;
c) receiving from said server a confirmation that a payment for a retail transaction has been made;
wherein
said confirmation from said server indicates that said server has received details regarding said retail transaction conducted at said retail establishment.

10. A method according to claim 9 wherein step a) comprises taking a digital image of an optical machine-readable representation of data, said representation being located at said retail establishment, said token being derived from said machine-readable representation.

11. A method according to claim 9 wherein said token is selected by said user from a group of available tokens for said retail establishment.

12. A method according claim 9 wherein token is fixed for each point of sale terminal at said retail establishment.

13. A method according to claim 9 wherein said retail establishment is a restaurant.

14. A method according to claim 13 wherein each table at said retail establishment is assigned a fixed token to be obtained by said user.

15. A method according to claim 9 wherein said token is selected by said retail establishment from a group of available tokens.

16. Computer readable media having encoded thereon computer readable instructions which, when executed, implements a method for processing payments for a retail establishment, the method comprising:
a) receiving at a server a first token from an identified user, said user being identified by said server;
b) receiving at said server a second token from said retail establishment, said second token being received from said retail establishment and being sent to said server with details regarding a retail transaction at said retail establishment;
c) determining if said first token and said second token match each other;
d) in the event said first token and said second token match each other, matching said details with said identified user in said server;
e) paying said retail establishment for said retail transaction on behalf of said identified user.

17. Computer readable media having encoded thereon computer readable instructions which, when executed, implements a method for paying for a retail transaction at a retail establishment for a user of a mobile computing device, the method comprising:
a) obtaining a token at said retail establishment by way of said mobile device;
b) transmitting said token to a server using said mobile device, said mobile device being registered and identified with said server and said mobile device being associated with at least one payment method with said server;
c) receiving from said server a confirmation that a payment for a retail transaction has been made;
wherein
said confirmation from said server indicates that said server has received details regarding said retail transaction conducted at said retail establishment.
